(19) United States
(12) Patent Application Publication
(10) Pub. No.: US 2024/0402040 A1
(43) Pub. Date: Dec. 5, 2024

(54) METHOD FOR THE FUNCTIONAL CHARACTERISATION OF OPTICAL LENSES

(71) Applicant: FOGALE NANOTECH, Nîmes (FR)

(72) Inventors: Eric LEGROS, Nîmes (FR); Sylvain PETITGRAND, Caissargues (FR)

(21) Appl. No.: 18/701,025

(22) PCT Filed: Oct. 21, 2022
(86) PCT No.: PCT/EP2022/079416

§ 371 Date: Apr. 12, 2024

(30) Foreign Application Priority Data
Oct. 21, 2021 (FR) FR2111204

(51) Int. Cl. G01M 11/02; G01B 9/0209; G01B 11/24

(52) U.S. Cl. CPC G01M 11/0271; G01B 9/0209; G01B 11/2441; G01M 11/0292

(57) ABSTRACT

A method and related device for functional characterization, during manufacture or after manufacture, of a target optical objective including the following steps and performed after stacking the optical elements of the target objective: measuring, by optical interferometry, at least one measured optical set, including data relating to at least one geometric parameter of at least one optical interface; and providing, based on the at least one measured optical set, an estimated performance set including data relating to the performance of the target objective, by a characterization model previously trained. Also provided are a method and a system for manufacturing optical objectives implementing such a characterization method or device.

The present invention relates to a method for characterizing an optical objective, in particular during or after the manufacture thereof, so as to determine an indicator of functional performance. It also relates to a device for characterizing optical objectives implementing such a method. It relates moreover to a method and a system for the manufacture of optical objectives implementing such a characterization method or device.

The field of the invention is the field of qualitative characterization of optical objectives.

### STATE OF THE ART

Optical objectives are used in various appliances, such as for example cameras for video and still photography, smartphones, etc. for imaging a scene, or as a light source, to project patterns, to light a scene, etc.

An optical objective is constituted by a stack of optical lenses: convergent, divergent, aspherical, or optionally other complex shapes, separated from one another by an air gap, or by a spacer. They are generally assembled using a device known as a tube or barrel. Once assembled, the optical objective is tested to determine a performance data item relating to the functioning of said objective, mainly to validate or not the functional quality of said objective.

Currently there are different techniques for testing an optical objective during manufacture.

Test techniques using functional measurements, such as for example the technique of characterization by modulation transfer function (MTF), are known. This technique makes it possible, by a contrast reading at several measurement points on the optical objective, to validate or not the performance of said optical objective at the end of manufacture. The test techniques using functional measurements, and in particular the MTF technique, are time-consuming techniques. In addition, these techniques concentrate on the optical objective after manufacture thereof, so that when the tested optical objective is non-compliant, the manufacture thereof constitutes a total loss of time and money.

A technique also exists for individually characterizing the optical elements composing the optical objective, before manufacture thereof. This technique envisages measuring values of individual parameters on each optical element of the objective and comparing this value to predetermined tolerance ranges. However, the number of parameters involved in this technique can be high, which also makes these techniques time-consuming. In addition, in reality it is difficult to forecast the correlations between the individual parameters of each optical element of an optical objective and the final performance thereof. In fact, it has been observed that maintaining the individual parameters of an optical element within a range of values does not necessarily guarantee the performance of a manufactured optical objective which will also depend on the context of the other individual parameters and the combinations, favourable or not, of the parameters within the range of values thereof. These situations show that the existing state of the art is not very efficient.

An aim of the present invention is to overcome at least one of the aforementioned drawbacks.

Another aim of the invention is to propose a solution for characterization of optical objectives that is less time-consuming.

Another aim of the invention is to propose a solution for characterization of optical objectives that is simpler and more scalable as a function of the architecture of the optical objectives.

Yet another aim of the invention is to propose a solution for characterization of optical objectives that has better performance.

### DISCLOSURE OF THE INVENTION

The invention proposes to achieve at least one of the aforementioned aims by a method for functional characterization, during manufacture or after manufacture, of an optical objective, called target optical objective, comprising several optical elements, said method comprising a phase of characterization of said target objective comprising the following steps and performed after stacking said optical elements:
measuring, by optical interferometry on said stack of optical elements, at least one data set, called measured optical set, comprising data relating to at least one geometric parameter of at least one optical interface of said target objective; and
providing, based on said at least one measured optical set, a data set, called estimated performance set, comprising estimated data relating to the performance of said target objective, by a characterization model previously trained with a database, called training database, of training sets constituted on the basis of optical objectives with an architecture identical to that of said target objective.

Thus, the method according to the invention proposes to predict, during manufacture thereof, the functional performance of an optical objective comprising a stack of several optical elements, based on optical interferometry measurements relating to the optical interfaces of said objective, without having to perform functional measurements relating to said optical objective, for example by a method of the MTF type. In addition, the invention proposes to characterize an optical objective without having to characterize individually each optical element of the optical objective. Thus, the solution proposed by the present invention is less time-consuming and simpler than the current solutions.

In addition, in the present invention, the measured optical set is determined by optical interferometry on an assembly of optical elements forming the objective after said optical elements have been stacked, and not on each optical element individually. Thus, the characterization is performed by taking into account at least one of the optical elements, but also the association thereof with other optical elements forming the optical objective, which allows a more complete characterization that is closer to the reality, and therefore more realistic and with better performance.

Advantageously, according to the invention the measured optical set is obtained by a measurement carried out only from one face, or one side, of the stack without having to turn said stack over. Thus, the measured optical set is obtained more rapidly. In this case, the optical interferometer makes it possible to measure data relating to each optical interface of the objective, including each optical interface, called “buried” optical interface, i.e. an optical interface that is visible only through another optical interface of said objective.

The optical elements composing an optical objective are stacked according to a stacking direction, also called axis Z hereinafter, or also the axis of the optical objective. The plane perpendicular to the axis Z, i.e. the plane along which each optical element extends, is called the plane X-Y hereinafter.

In the present application, the measurement step makes it possible to obtain a measured optical set relating to the geometry of the optical interfaces of the objective, also called “geometric parameter” of the interface.

By “geometric parameter of an optical interface” is meant, for example, and without loss of generality:
a position of the optical interface within the objective, according to the axis Z
a position of an APEX of the optical interface, in particular in the plane X-Y and/or
a position of an APEX of the optical interface, in particular according to the axis Z
an inclination (TIP and/or TILT) of said optical interface with respect to the axis Z
a decentration of an optical interface, or of an optical element, with respect to the axis Z, in the plane X-Y.

By “buried optical interface” is meant an interface which, during the optical interferometry measurement, is visible only via at least one other optical interface. The at least one other optical interface through which the buried interface is visible can be an optical interface of a same optical element, or an optical interface of another optical element.

Two optical objectives have an identical architecture when each of these objectives comprises by design identical optical elements that are stacked by design in identical fashion.

According to the invention, the measurement step is performed by optical interferometry.

The optical interferometry can be performed with an optical interferometry appliance, which according to the invention, makes it possible to measure at least one data item relating to a geometry of at least one optical interface of the target objective. According to a particular embodiment example, the optical interferometry appliance comprises a low-coherence light source emitting, in the direction of stacking of optical elements, and more particularly according to the axis Z, a light beam, called measurement beam. The measurement beam illuminates the stack of optical elements at a measurement point that is more or less wide according to the focusing in the plane X-Y, and then travels through the stack of optical elements, in particular in the direction of stacking, and passes through each optical interface in turn. At each optical interface, a part of the beam is reflected, and constitutes a reflected beam. This reflected beam is then captured by a sensor located on the same side as the emission source, and is characterized by optical interferometry with a reference beam also originating from the light source. By “coherence area” is meant the area in which interferences between the measurement beam and the reference beam can form on the sensor. The coherence area can be moved by varying the difference in the length of the optical path between the two beams, for example by modifying the optical length of one or both of the beams. The optical interferometry appliance makes it possible to detect an interference signal selectively for each interface at the level of which the coherence area is positioned, i.e. for each surface located in the coherence area. Preferably, the coherence length of the light source is adjusted so as to be shorter than a minimum optical distance between two adjacent interfaces of the optical element. Thus, for each measurement, a single interface is located in the coherence area, and an acquired interference signal therefore comprises only the contribution of a single interface, or only originates from a single interface. The interference measurements are carried out according to a field of view determined by the measurement means of the device.

According to an embodiment, the interferometric appliance can operate in point mode by being configured to detect a point interference signal at a point of the field of view or in a point sensor. The measured optical set can be, or can comprise, the interference signal or interferogram that is an intensity signal depending on the displacement of the coherence area along the axis z. The interference signal can, for example, be seen as a succession of interference rays associated with each optical interface.

Alternatively or in addition, the optical interferometry appliance can comprise an interferometric sensor, called full-field interferometric sensor, configured to detect a full-field interference signal in a field of view and represented, for example in the form of a 2D image (interference image) by virtue of the detection element.

An interface to be measured can thus be imaged according to the field of view in a single measurement or by a scanning beam.

In a particular example of implementation, a measurement signal can be formed by a point interference signal associated with a pixel of the detection element the intensity of which is detected according to the displacement along Z of the coherence area.

According to an example, the interferometric device can comprise an interferometric sensor with a Michelson interferometer. According to another example, the interferometric device can comprise an interferometric sensor with a Mach-Zehnder interferometer.

According to embodiments, a point-mode interferometry appliance and a full-field interferometry appliance can be combined.

The optical interferometry measurement between the measurement beam and the reference beam makes it possible to provide raw measurement data that comprise, for optical interfaces:
in point mode: at least one interference ray the position and the amplitude of which depend on the geometric distance at which said optical interface is located, with respect to a reference point/plane, at the measurement point. In particular, the reference point/plane is the point/plane of emission of the measurement wave, or of a known reference interface forming part of the measurement device. Thus, the position of an interference ray makes it possible to determine the distance at which the optical interface that is associated therewith is located, at the measurement point.
in full-field mode: a sequence of 2D interference signals acquired for a plurality of differences of optical paths making it possible to obtain items of shape information of the optical interfaces. These sequences can be acquired in different ways according to the analysis technique implemented. The plurality of 2D interference signals can in particular be acquired according to a phase-shifting interferometry method or according to a vertical scanning interferometry method. According to another embodiment that is in no way limitative, the interference signal can be processed by a digital holography calculation method. Typically, the 2D interference signals include an item of amplitude information and an item of phase information. Images associated with these items of amplitude information and images associated with these items of phase information can be constructed from interference signals.

According to embodiments, the measurement step can perform a single measurement providing a single measured optical set. In this case, this single optical set is given as input to the functional characterization model, optionally after processing.

For example, the measurement step can perform a single optical interferometry measurement on the stack of optical elements. Such an interferometry measurement can for example provide an optical set comprising:
raw measurement data representing the interference signal,
raw measurement data relating to positions, and optionally to amplitudes, of interference rays;
measurement data, called raw measurement data, relating to interference images of an optical element, containing items of intensity information and items of phase information;
distance values between the optical interfaces, or the optical elements, obtained by processing the raw data;
topography data obtained by processing the raw data;
thickness data of each optical element;
position data according to the axis Z;
alignment data with respect to the axis Z in the plane X-Y; or
inclination data with respect to the axis Z.

According to embodiments, the measurement step can perform several optical interferometry measurements providing one or more measured optical set(s).

For example, the data acquired during several optical interferometry measurements can be processed to provide a single optical set, by consolidation or by concatenation of the data obtained for each measurement. Alternatively, each optical interferometry measurement can provide a measured optical set.

For example, the measurement step can provide any combination of at least one of the following measured optical sets:
a measured optical set relating to the positions of the optical interfaces, or of the optical elements, according to the axis Z: such a measured optical set can be obtained by one or more optical interferometry measurements;
a measured optical set relating to the thicknesses of the optical elements, according to the axis Z: such a measured optical set can be obtained by one or more optical interferometry measurements;
a measured optical set of the surface profile of the optical interfaces: such a measured optical set can be obtained by one or more optical interferometry measurements;
a measured optical set relating to a decentration of each interface, or optical element, of the stack with respect to the axis of Z or relatively to a centre position of another interface, in the plane X-Y;
a measured optical set relating to an inclination of each interface, or optical element, of the stack with respect to the axis of Z or relatively to the inclination of another interface.

According to embodiments, at least one optical set can comprise, partially or wholly, raw measurement values provided by at least one optical interferometry measurement.

For example, the measured optical set can comprise the measured interference signal.

For example, the optical set can comprise raw data representing, for at least one interference ray, the position and optionally the amplitude of said interference ray.

According to another example, the measured optical set can comprise raw data representing the amplitude image and/or the phase image associated with an interference image.

An example of raw measurement data is given hereinafter with reference to FIG. 2b for an example of point-mode interferometry and with reference to FIGS. 2c-2f for an example of full-field mode interferometry.

According to embodiments, at least one measured optical set can comprise at least one geometric value relating to at least one optical interface of the objective, the measurement step comprising the following steps:
at least one optical interferometry measurement, each providing raw data, and
calculating said at least one geometric value by processing of said raw data.

Such a geometric data item can comprise any one of the following data items:
at least one position value of an optical interface, or element, of the objective;
at least one thickness value of an optical element of the objective;
at least one decentration value of at least one optical interface, or element, with respect to the axis Z, or relative to a centre position of another interface, in the plane X-Y; or
at least one inclination value of at least one optical interface, or element, with respect to the axis Z, or relative to the inclination of another interface;
at least one topography or shape profile value of at least one interface.

The position according to the axis Z of an optical interface can be determined as being the position of an interference ray corresponding to said interface.

The thickness of an optical element, according to the axis Z, can be determined by calculating the distance between the interference rays corresponding to each of the optical interfaces of said optical element.

The position of an optical interface with respect to the axis Z can be determined by carrying out several optical interferometry measurements, in particular in a central area of the optical objective. By following, over the several measurements, the position according to the axis Z of the interference ray associated with said interface, it is possible to determine the position of the APEX of said optical interface. The position of the APEX of the optical interface makes it possible to determine the position of said interface with respect to the axis Z, in the plane X-Y, and therefore its decentration with respect to the axis Z.

In another example, the position of an interface with respect to the axis Z can be obtained, for example, by detecting an interference image of the interface in a central area of the optical objective, and analysis of this image and/or analysis of the associated images of amplitudes or phases, in particular to obtain a profile of this surface and the position of the APEX of said optical interface.

The position of an optical element with respect to the axis Z can be determined based on the positions of these optical interfaces.

The inclination of an optical interface with respect to the axis Z can be determined by carrying out several optical interferometry measurements, in particular in a peripheral area of the optical objective. By following, over the several measurements, the position in the axis Z of the interference ray associated with said interface, it is possible to determine the position of the interface according to the axis at the level of the edges thereof, which makes it possible to determine the inclination of said interface with respect to the axis Z.

The inclination of an optical element with respect to the axis Z can be determined based on the inclinations of the optical interfaces thereof.

It is also possible to determine each of these geometric parameters by using the amplitude of an interference ray, in addition to, or instead of, the position of the interference ray.

By way of indication, for an objective produced with a stack of N lenses, it is possible to consider for each lens a parameter for the refractive index and optionally a second for the chromatic dispersion thereof if it is decorrelated, 4 parameters for the tilt and the centring per lens face, 2 parameters for the thickness and the air gap, i.e. a total of (10×N−1) to (11×N−1) parameters describing the stack.

Commercially available equipment for measuring performance assesses it for example on 27 points of the screen. Thus, according to a non-limitative embodiment, the characterization model can be envisaged to model the relationships between these (10×N−1) to (11× N−1) parameters on the one hand and for example 27 on the other.

According to embodiments, the characterization model can comprise:
a neural network, in particular a regression neural network, and even more particularly a deep learning convolutional neural network, CNN. Such a neural network can, non-limitatively, for example comprise at least one hidden layer associated with non-linear outputs for modelling the non-linear behaviours of the relationships to be learned, and a number of neurones in a first layer in relation to the number of performance measurement points, and a number of coefficients for each neurone in relation to the number of parameters describing the stack and the optical indexes of the lenses;
a polynomial linear regression model;
a Gaussian equation, obtained by a least squares method; or
a statistical analysis method.

According to embodiments, at least one training set can comprise:
at least one optical set, called training optical set, relating to an optical objective with an architecture identical to the architecture of the target objective, and
at least one performance set, called training performance set, comprising data relating to the performance of said optical objective.

Of course, each training optical set, respectively each training performance set, comprises data of the same nature presented according to a same formalism as the measured optical set, respectively the estimated performance set. Consequently, all the characteristics described above with reference to the measured optical set, respectively to the estimated performance set, are applicable to the training optical set, respectively to the training performance set.

According to particularly advantageous embodiments, at least one training set can be obtained from an objective forming part of a same batch of objectives as the target objective, during the manufacture of said batch of objectives. In other words, in this case, the training database is obtained, partially or wholly, by measurements performed on the optical objectives forming part of the same batch as the target optical objective and which were manufactured beforehand.

Thus, the characterization model is more precise and makes it possible to perform a more precise functional characterization.

By “objectives from the same batch” is meant objectives that originate from a same architecture (same design) conceived so that the objectives produce a similar optical performance. Additionally, these objectives can also have common characteristics of manufacture such as originating from a same production line, be produced with a common machine, at similar periods, etc.

In this case, a first part of the manufactured optical objectives from a same batch is used to constitute a training database. In particular, for each optical objective from this first part of the batch, a training set is constituted by performing, for said manufactured optical objective:
at least one optical interferometry measurement in order to obtain at least one training optical set, and
at least one functional measurement in order to obtain at least one training performance optical set.

Thus, the first manufactured optical objectives from a batch make it possible to constitute a training database. This latter is used to train the characterization model. Once the characterization model is trained, it is used to characterize the following optical objectives of said batch, during the manufacture thereof.

According to embodiments, for at least one training set:
the training optical set is obtained by simulation; and/or
the training performance set is obtained by simulation.

For example, during the design phase of an objective, the architecture thereof can be modelled by representing the optical interfaces (particularly those of the lenses) by analytical formulations and by indicating digitally the spacing thereof. The theoretical values of the refraction index and the Abbe number of the materials involved can also be data. These theoretical values can then be input into commercially available optical design software to simulate and optimize the parameters defining the objective by calculating the theoretical functional performance. For example the OpticStudio software from Zemax is known, which calculates the propagation of light rays through stacks of optical interfaces, by calculating, each time a new interface is passed through, a reflected beam and a transmitted beam on the basis of an incident beam, by digitally implementing the Snell-Descartes laws. It is thus possible to calculate the optical transfer properties quite accurately by simulating the propagation of optical rays, for different points of the scene to be viewed, and the different associated points on the detection area. These transfer functions can thus be transformed by the software into an MTF calculation result by frequency-domain transform, around each chosen detection point.

Thus, the training optical set and/or the training performance set composing at least one training set can be obtained by simulation. Thus, the training database can be constituted, partly or wholly, by simulation, which is quicker and requires less effort and fewer resources.

For example, at least one estimated performance set, respectively a measured or simulated training performance set, can comprise:
at least one wavefront characterization value, or
at least one modulation transfer function, or MTF value;
   for at least one position on the objective.

The estimated performance set is provided by the characterization model.

As explained above, the training performance set is either measured on a real objective, or provided by simulation based on a digital modelling of an optical objective.

According to embodiments, the method according to the invention can comprise prior to the first iteration of the characterization phase, a phase of training the characterization model with the training database.

According to another aspect of the present invention, a device is proposed, for functional characterization, during manufacture or after manufacture, of a target optical objective comprising a stack of several optical elements, said device comprising:
An optical interferometry device for measuring, on said stack of optical elements, at least one data set, called measured optical set, comprising data relating to at least one geometric parameter of at least one optical interface of said target objective; and
a characterization model previously trained with a training database constituted on the basis of optical objectives with an architecture identical to that of said target objective in order to provide, based on said at least one measured optical set, a data set, called estimated performance set, comprising data relating to the performance of said target objective.

The characterization device can optionally comprise any combination of at least one of the characteristics described above with reference to the characterization method according to the invention, which for the sake of brevity will not be repeated here in detail.

In particular, the characterization model can be integrated in a computer processing module, such as a processor, a chip, a computer, a tablet, a server, etc, whether dedicated or not.

In particular, the characterization model can be integrated in the optical interferometry appliance. Alternatively, the characterization model can be located in an appliance independent of said measurement appliance.

According to another aspect of the present invention, a method is proposed for the manufacture of a batch of optical objectives including a second manufacture phase comprising at least one iteration of a step of manufacture of an optical objective of said batch comprising the following operations:
stacking the optical elements forming said optical objective; and
characterizing said objective by the characterization method according to the invention.

The estimated performance set obtained for the optical objective can be compared to at least one range of performance values to determine if the estimated performance of the optical objective is satisfactory.

If the estimated performance of the optical objective is satisfactory, then the optical objective will be retained.

If the estimated performance of the optical objective is not satisfactory, then the optical objective can be subjected to at least one other test, for example an MTF or wavefront measurement by a device provided for this purpose, so as to verify the performance of the optical objective by measuring.

Alternatively or in addition, if the estimated performance of the optical objective is not satisfactory, then the optical objective can be reworked to improve the performance thereof. For example, at least one optical element of the optical objective can be repositioned or replaced.

In any case, this optical objective can contribute to the construction of the training database.

Advantageously, the method of manufacture according to the invention can comprise a first manufacture phase, prior to the second manufacture phase, comprising at least one iteration of a step of manufacture of an optical objective of said batch comprising the following operations:
stacking the optical elements forming said optical objective,
measuring, by optical interferometry, at least one training optical set on said optical objective,
measuring at least one training performance set, and
storing, in a training database, a training set formed by:
   said at least one training optical set, and
   said at least one training performance set.

This first manufacture phase makes it possible to constitute a training database for training the characterization model used during the second manufacture phase.

According to another aspect of the present invention, a system for the manufacture of optical objectives is proposed comprising:
at least one means of stacking the optical elements forming an optical objective; and
a device for characterizing said optical objective according to the invention;
   configured to implement the method of manufacture according to the invention.

The system of manufacture can also comprise an appliance for measuring an item of performance data of an optical objective, such as an MTF measuring appliance or a wavefront measuring appliance.

### DESCRIPTION OF THE FIGURES AND EMBODIMENTS

Other advantages and characteristics will become apparent on examining the detailed description of embodiments that are in no way limitative, and from the attached drawings, in which:

FIG. 1 is a diagrammatic representation of a non-limitative embodiment example of an optical objective capable of being characterized by the present invention;

FIGS. 2a to 2f are diagrammatic representations of a non-limitative embodiment example of optical interferometry measurement capable of being implemented in the present invention;

FIG. 3 is a diagrammatic representation of a non-limitative embodiment example of a method according to the invention for functional characterization of an optical objective;

FIG. 4 is a diagrammatic representation of a non-limitative embodiment example of a device according to the invention for functional characterization of an optical objective;

FIG. 5 is a diagrammatic representation of a non-limitative embodiment example of a training phase capable of being used in the present invention for training a functional characterization model; and

FIG. 6 is a diagrammatic representation of a non-limitative embodiment example of a method according to the invention for the manufacture of an optical objective.

It is well understood that the embodiments that will be described hereinafter are in no way limitative. Variants of the invention can be envisaged in particular comprising only a selection of the characteristics described hereinafter, in isolation from the other characteristics described, if this selection of characteristics is sufficient to confer a technical advantage or to differentiate the invention with respect to the state of the prior art. This selection comprises at least one, preferably functional, characteristic without structural details, or with only a part of the structural details if this part alone is sufficient to confer a technical advantage or to differentiate the invention with respect to the state of the prior art.

In particular, all the variants and all the embodiments described can be combined together if there is no objection to this combination from a technical point of view.

In the figures and in the description hereinafter, elements common to several figures retain the same reference.

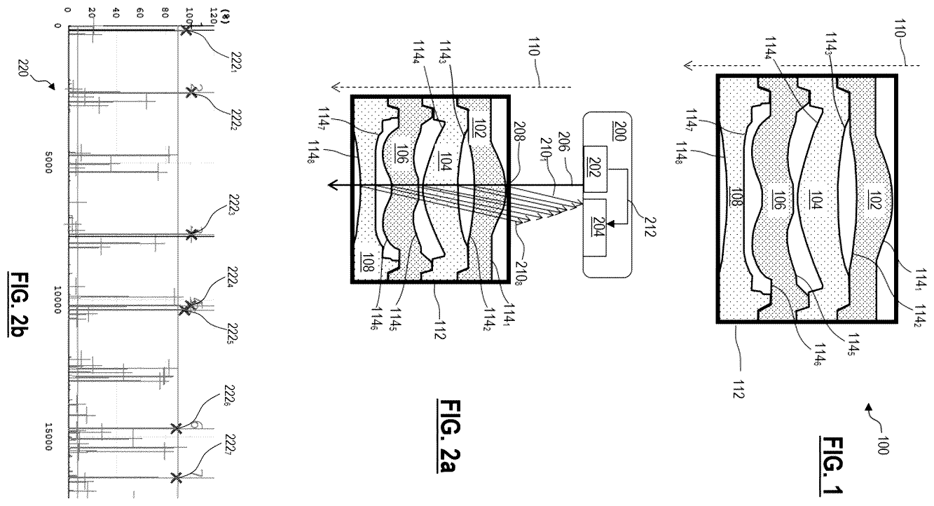

FIG. 1 is a diagrammatic representation of a non-limitative embodiment example of an optical objective capable of being characterized by the present invention.

An optical objective has the function of focusing an image of a scene in an image plane, generally constituted by a CMOS camera (called “CMOS imager system” giving the acronym CIS). Such an optical objective is generally constituted by a stack of optical elements comprising any combination of optical elements such as lenses, spacer and opacification rings, etc.

During the manufacture of the optical objective, also called “objective” hereinafter, each optical element of said objective is selected individually and stacked with the other optical elements in an assembly barrel, following a given order. The stack and barrel are then firmly fixed together by known techniques, for example by bonding.

After manufacture thereof, the optical objective is functionally tested by known techniques, such as for example MTF measurements, so as to test the performance of said objective. Briefly, the MTF measurement makes it possible to test the contrast quality of the image of a test chart, at different points of the image, and if necessary for different distances between the test chart and the measurement system, with, if necessary, different adjustments, or adjusting the objective/image distance to obtain sharpness. The MTF measurement provides a set of values for functional parameters. These values are then tested to determine if each value of a parameter falls within a predetermined range associated with this parameter. If all the values measured, or most of the values measured, fall within the predefined ranges, then the functional performance of the objective is judged to be satisfactory.

Of course, the MTF measurement is given by way of example only and is in no way limitative. Other measurement techniques can be used to test the quality of the optical objective, such as for example a wavefront measurement technique.

It is noted that hereinafter:
“JPE” is an estimated performance set according to the present invention with the characterization model;
“JPA” is a training performance set, either measured by a technique testing the functional quality of the objective (MTF or wavefront for example), or estimated by simulation.

In FIG. 1, and by way of non-limitative example only, the objective 100 comprises four lenses 102-108 stacked in a stacking direction 110, also called axis Z, in a barrel 112. At least two of the lenses 102-108 can be separated from one another by a void space, called “air gap” or by a spacing sleeve or ring, also called “spacer”.

Each lens has two interfaces, namely an interface called upstream, and an interface called downstream, in the stacking direction 110. Thus, the lens 102 has an upstream interface 114₁ and a downstream interface 114₂, the lens 104 has an upstream interface 114₃ and a downstream interface 114₄, the lens 106 has an upstream interface 114₅ and a downstream interface 1146 and the lens 108 has an upstream interface 114₇ and a downstream interface 114₈.

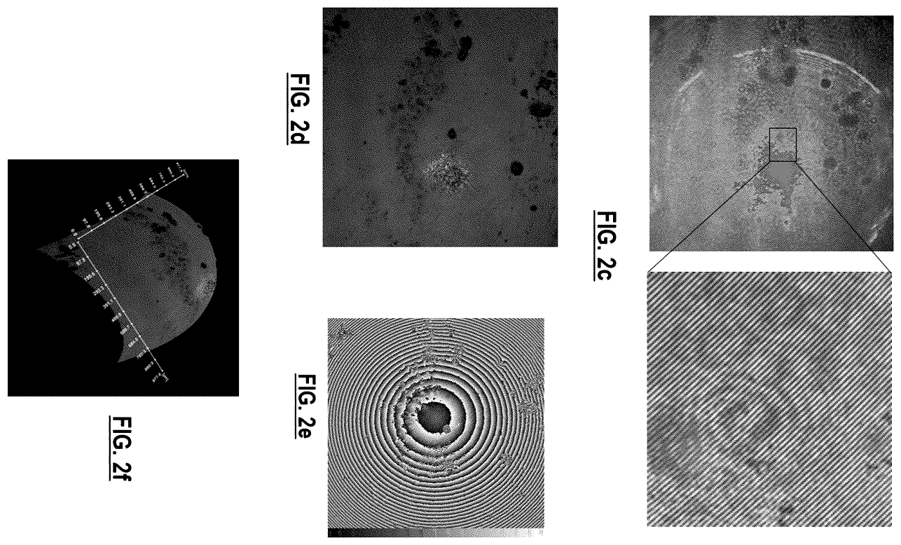

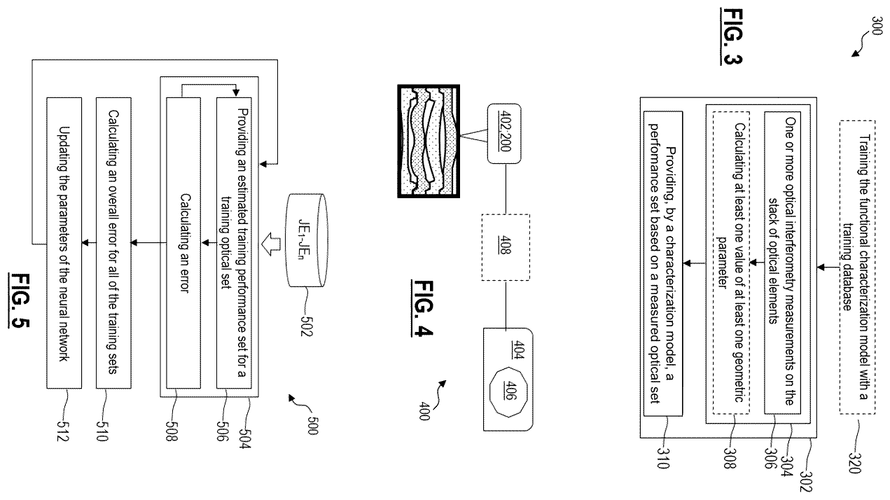

FIG. 2a is a diagrammatic representation of a non-limitative embodiment example of an optical interferometry measurement capable of being implemented by the present invention.

The optical interferometry measurement is performed by an optical interferometry appliance 200, shown very diagrammatically in FIG. 2a. The appliance 200 comprises a light source 202 and an interferometry sensor 204. The source 202 emits, in the stacking direction of optical elements, a coherent light beam 206, called measurement beam, for example a laser beam, at a measurement point, or according to a field of view, 208 in the plane X-Y, perpendicular to the direction 110. The measurement beam 206 then travels through the stack of optical elements, in particular in the axis Z 110, and passes through each optical interface 114; in turn. At each optical interface 114i, a part 210; of the measurement beam 206 is reflected, such that:
a beam 210₁ is reflected by the interface 114₁,
and so on and so forth
a beam 210₈ is reflected by the interface 114₈.

Each reflected beam 210; of the measurement beam 206 is then captured by the sensor 204 located on the same side as the emission source 202, and will produce an interference signal when this reflected beam 210; and a reference beam 212, also originating from the light source 202, recombine on the sensor 204, the difference in the paths travelled by the two respective beams being less than the coherence length of the emission source 202. In particular, for each reflected beam 210; the sensor 204 provides an interference ray, called main ray, or an interference image, according to the illumination and detection modes implemented, at an optical distance corresponding to the position of the interface with respect to the emission source 202, or any other predetermined reference. Of course, apart from the beam 210; reflected by the first interface 114₁ encountered by the measurement beam 206, a part of each of the other reflected beams 210₂-210₈ can itself be reflected in the other direction on passing through a preceding interface, which can generate multiple reflection optical beams (not shown) captured by the sensor 204. These multiple reflection beams generate interference rays, called secondary rays, or secondary images, generally of lower amplitude.

The optical interferometry measurements can be performed with a measurement beam of an interferometric sensor illuminated by a low-coherence light source. To this end, the optical interferometry appliance has available positioning means for relatively positioning a coherence area of the interferometric sensor 204 at the level of the interface to be measured. The interface to be measured can be a “buried” interface, i.e. one of the interfaces inside the optical element. In order to reach such a buried interface, the measurement beam must therefore pass through other interfaces of the optical objective. The device according to the invention makes it possible to detect an interference signal selectively for each interface at the level of which the coherence area is positioned, i.e. for each surface located in a coherence area, since the coherence length of the light source is adjusted so as to be shorter than a minimum optical distance between two adjacent optical interfaces of the optical objective. Thus, preferably, for each measurement, a single interface is located in the coherence area.

The interference measurements can be performed according to a field of view determined by the measurement means of the device. The measurements can thus be performed either full-field, or by scanning the field of view.

Digital processing means can be configured to produce, from the interference signal, an item of shape information of the interface measured according to the field of view.

Examples of interferometric devices capable of being utilized in the context of the present invention are described in the document WO2020/245511 A1. Devices utilizing illumination according to a measurement point and/or a field of view are described therein.

FIG. 2b gives a partial diagrammatic representation of raw measurement data obtained for an optical interferometry measurement, such as that described with reference to FIG. 2a.

In this example implementation, an illumination according to a measurement point is used and the coherence area is displaced along the optical axis Z 110 by virtue of displacement means.

Thus, as described with reference to FIG. 2a, each interference measurement provides raw data 220. The raw data 220 comprise main rays 222i, each main ray corresponding to an optical interface. For example, a main ray 222₁ is obtained for the interface 114₁, a main ray 222₂ for the interface 114₂, etc. (the interface 114₈ does not appear in the example shown in FIG. 2b).

The raw data 220 also comprise secondary rays corresponding to multiple reflections, and associated with the interfaces 114₂-114₈.

The optical position of each ray is given on the x-axis and the normalized amplitude of each ray is given on the y-axis.

FIGS. 2c-2f are partial diagrammatic representations of another example of raw measurement data obtained for an optical interferometry measurement, such as that described with reference to FIG. 2a.

In the example shown in FIGS. 2c-2f, an illumination according to a full-field mode is used and the coherence area has been positioned so as to measure a buried lens surface. FIG. 2c shows the interference signal detected during a digital holography microscopy (DHM) measurement.

FIGS. 2d and 2e show respectively the amplitude and phase images (in this folded example) calculated from the interference signal. FIG. 2f is an image of the topography of the surface of a buried lens obtained from the phase information.

According to embodiments of the method according to the invention for characterization of an optical objective, it is possible to use a measured optical set comprising raw measurement data, partially or wholly, namely:
in an illumination configuration according to a measurement point, for example:
   the position, and optionally the amplitude, of each main ray, or
   the position, and optionally the amplitude, of each ray, (main and secondary);
in an illumination configuration according to a field of view, for example:
   the interference image detected by the interferometry sensor 204,
   the amplitude image associated with the interference image and/or the phase image associated with the interference image, or
   the topography image associated with the interference image.

According to embodiments, it is possible to use a measured optical set comprising, not raw measurement data obtained by an optical interferometry measurement, but geometric parameter values relating to the optical interfaces of the objective, namely:
the position, along the axis Z, of each interface 114; or of each optical element 102-108. These distance values can be obtained based on the raw data from a single interferometric measurement. In this case, the measured optical set comprises a distance value per interface, respectively per optical element;
the decentration with respect to the axis Z or relative to other interfaces in the plane X-Y, of each interface 114; or of each optical element 102-108. These decentration values can be deduced from an interference image associated with an optical interface, for example. In this case, the measured optical set comprises two (signed) distance values (one according to the axis X and the other according to the axis Y) for each interface, respectively optical element;
the inclination with respect to the axis Z or to the inclination of other optical interfaces of each optical interface 114; or of each optical element 102-108. These inclination values can be deduced from several interferometric measurements performed at different measurement points, in particular in a peripheral area of the optical objective. In this case, the measured optical set comprises two angle values (one with respect to the axis X and the other with respect to the axis Y) for each interface, respectively optical element.

It is noted hereinafter that JO is a measured optical set obtained by optical interferometry measurement on the stack of the optical elements composing the optical objective.

According to embodiments, it is possible to use a single measured JO of an optical objective to estimate an estimated performance set, JPE, of said objective.

According to embodiments, it is possible to use several measured JO to estimate a JPE for a target optical objective. In this case, the measured JOs can be concatenated or provided individually. For example, it is possible to use a JO relating to the position in the axis Z, a measured JO relating to the decentration with respect to the axis Z in the plane X-Y, and a measured JO relating to the inclination with respect to the axis Z.

FIG. 3 is a diagrammatic representation of a non-limitative embodiment example of a method according to the invention for functional characterization of an optical objective.

The method 300 in FIG. 3 can be used for characterizing an optical objective comprising several lenses, such as for example an optical objective 100 in FIG. 1, without being limited thereto.

The method 300 comprises a phase 302 of characterization of an optical objective, called target objective, during manufacture thereof.

The characterization phase 302 comprises a step 304 of optical interferometry measurement on the stack of optical elements of the target objective. This measurement step 304 performs, on the stack of optical elements of the objective, one or more optical interferometry measurements 306, such as for example the optical interferometry measurement described with reference to FIGS. 2a-2f, without being limited thereto.

This measurement step 304 provides one or more measured optical sets JO₁-JOₘ, with m≥1.

According to a non-limitative example, each measured optical set JOᵢ comprises the position of each main interference ray such that JOᵢ= {P_{1,i}, . . . , P_{n,i}}, with n the interface number and n≥2. Of course, each measured optical set JOᵢ can comprise other data, as described above with reference to FIGS. 2a-2f.

When at least one measured optical set JOᵢ comprises at least one value of at least one geometric parameter relating to at least one optical interface, or an optical element, of the target objective, such as a geometric distance, a thickness, an inclination with respect to the axis Z, a decentration with respect to the axis Z in the plane X-Y, etc., the measurement step 304 comprises a step 308 of calculating said at least one value of the geometric parameter based on raw measurement data, for example based on the position, and/or the amplitude, of the interference rays. This step 308 is optional and is not necessarily implemented when the, or each, measured optical set JOᵢ comprises raw data.

During a step 310, the measured optical sets JO₁-JOₘ are provided to a characterization model previously trained. In response, this characterization model provides an estimated performance set JPE for said target objective.

The JPE can comprise one or more values. Preferably, the JPE comprises several values.

At least one value of a JPE can be an estimated value:
of a modulation transfer function (MTF); or
of a wavefront measurement, or also
of any other function for the functional characterization of the quality of the objective.
   for at least one measurement point of the target objective.

The characterization phase 302 can be repeated as many times as desired to characterize several target objectives.

Optionally, the method 300 can comprise a phase 320 of training the characterization model with a training database comprising several training sets obtained from objectives with an architecture identical to that of the target objective, or by measurement or by simulation.

Thus, the method 300 allows a functional characterization of the target optical objective by estimation with a characterization model previously trained, without performing any measurement of the functional quality of said target objective or measurement of the individual parameters of each optical element of the objective prior to the stacking thereof.

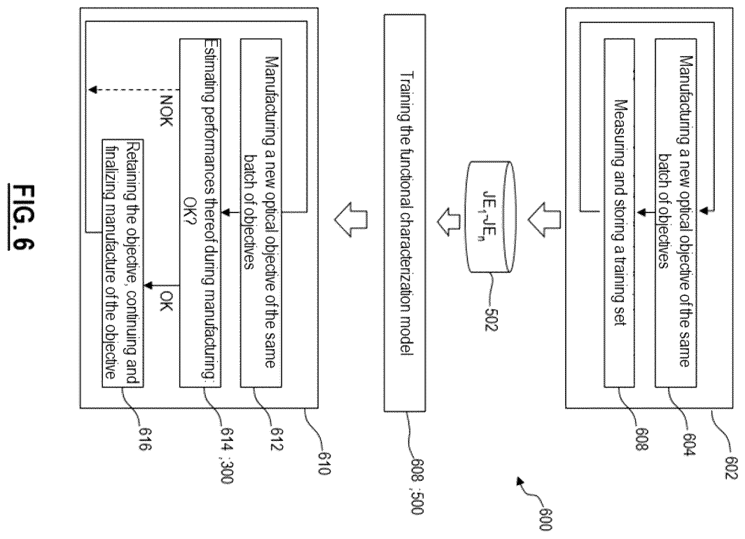

FIG. 4 is a diagrammatic representation of a non-limitative embodiment example of a device according to the invention for functional characterization of an objective during manufacture thereof.

The device 400 comprises an optical interferometry appliance 402 for performing at least one interferometric measurement so as to obtain at least one measured optical set. The appliance 402 can for example be the optical interferometry appliance 200 in FIG. 2a.

The device 400 also comprises a characterization module 404 executing a model 406 for the functional characterization of an optical objective, on the basis of at least one measured optical set. The functional characterization model 406 can be a computerized program or application and be presented in the form:
of a neural network, in particular a regression neural network, and even more particularly a deep learning convolutional neural network, CNN, or
a polynomial linear regression model,
a Gaussian equation, obtained by a least-squares method,
a statistical analysis method,
etc.

The characterization module 404 can be any calculation module or any computerized module executing the characterization model 406, such as a server, a computer, a tablet, a processor, a calculator, an electronic chip, etc.

Optionally, the characterization device 400 can comprise a calculation module 408 for calculating at least one value of a geometric parameter relating to the optical interfaces, or elements, of the optical objective, on the basis of raw measurement data provided by the optical interferometry appliance 402. In this case, the at least one measured optical set comprises geometric parameter values calculated by said calculation module 408.

FIG. 5 is a diagrammatic representation of a non-limitative embodiment example of a training phase capable of being used in the present invention for training a functional characterization model.

The training phase 500 in FIG. 5 can be used to train the characterization model used in the method according to the invention for the functional characterization of an optical objective, and for example the method 300 in FIG. 3, when the training model is a neural network.

The neural network used can be a CNN (for “convolutional neural network”), including for example a hidden layer. It is important to note that the number of neurones of the network is a function of the number of data items in the at least one measured optical set provided at input of said neural network, and of the number of data items in the at least one performance set desired at output.

The training phase 500 is performed with a training database 502 comprising numerous sets of training data, denoted JE₁-JEₖ. Each training set JEᵢ comprises:
at least one training optical set, JOAᵢ, obtained, by measurement or by simulation, from an optical objective the architecture of which is identical to that of the target optical objective that will be characterized by the characterization model, once trained;
a training performance set, JPAᵢ, obtained by measurement or by simulation, on said optical objective, by the functional characterization function the value of which it is desired to estimate, on the target objective, with the characterization model once trained, such as for example the MTF function.

The training phase 500 comprises a training step 504.

The training step 504 comprises a step 506 during which a training optical set, for example JOA₁, of a first training set, for example JE₁, is given at input of the neural network. The neural network gives at output an estimated training performance set, denoted JPA₁^{e}.

During a step 508, an error E₁ is calculated between the set JPA₁^{e} and the training performance set JPA₁, of said training set JE₁. The calculated error E₁ can for example be a Euclidean distance or a cosine distance between the set JPA₁^{e} and the set JPA₁.

The training step 504 is reiterated for each training set JE₁-JEₖ, SO that k error values E₁-Eₖ are obtained associated respectively with each training set JE₁-JEₖ.

During a step 510 an overall error is calculated for all of the training sets JE₁-JEₖ, for example by adding the k errors JE₁-JEₖ obtained.

During a step 512, the coefficients, or weightings, of the convolutional neural network are updated, for example by an error gradient retro-propagation algorithm.

The steps 504-512 are repeated several times until the overall error calculated in step 510 no longer varies during several, for example 5, successive iterations. When this is the case, the convolutional neural network is considered sufficiently trained.

Alternatively, or in addition to what has just been described, it is possible to use a first part of the training database 502, for example JE₁-JEⱼ, for training the neural network and a second part of the training database, for example JEⱼ₊₁-JEₖ, to validate the training of the neural network. If the outputs of the neural network obtained are sufficiently close to the expected values, the training is considered acceptable. Otherwise, further training sets are presented, or the topology of the network is modified (number of layers, number of neurones per layer, etc.) until a satisfactory training is obtained.

Of course the functional characterization model is not limited to a neural network.

According to an alternative, the functional characterization model can comprise, or can be, a correlation search method, for example by a regression method, between the training optical set JOAᵢ and the training performance set JPAᵢ of each training set JEᵢ.

According to an embodiment example, the correlation search can be done using a least-squares method. It can consist of establishing an assumed polynomial relationship between the JPAᵢ and JOAᵢ, for each JEᵢ. Then the least-squares method makes it possible to find the best set of polynomial coefficients that minimizes the error between the outputs calculated by the polynomials obtained and the JPAᵢ.

FIG. 6 is a diagrammatic representation of a non-limitative embodiment example of a method according to the invention for the manufacture of optical objectives according to the invention.

The method 600 can comprise a first phase 602 of manufacture during which a first part of a batch of objectives is manufactured. This first part comprises numerous optical objectives. During this phase 602 an optical objective is manufactured during a step 604, then a training set JE is measured and stored during a step 606, so as to constitute a training database, such as for example the training database 502.

Then during a step 608, the characterization model is trained with the training database, for example by implementing the training phase 500 in FIG. 5.

The method 600 can then comprise a second phase 610 of manufacture during which the remaining objectives of the batch are manufactured.

This phase comprises, for each optical objective, a step 612 of start of manufacture of said optical objective, at least up to the stacking of the optical elements composing said optical objective.

During a step 614, the optical objective being manufactured, or after manufacture, is characterized, by using the characterization model obtained in step 608, by the method according to the invention for functional characterization, and in particular by the method 300 in FIG. 3.

If the estimated performance of the optical objective is judged satisfactory, the manufacture thereof is continued or validated during a step 616.

If the estimated performance of the optical objective is not satisfactory, then the optical objective can be subjected to at least one other test, for example an MTF or wavefront measurement by a device provided for this purpose, so as to verify the performance of the optical objective by measuring.

Alternatively or in addition, if the estimated performance of the optical objective is not satisfactory, then the optical objective can be reworked to improve the performance thereof. For example, at least one optical element of the optical objective can be repositioned or replaced.

Of course, the invention is not limited to the examples that have just been described.

1. A method for functional characterization, during manufacture or after manufacture, of a target optical objective comprising several optical elements, said method comprising a phase of characterization of said target optical objective comprising the following steps and performed after stacking said optical elements:
measuring, by optical interferometry on said stack of optical elements, at least one data set, called measured optical set, comprising data relating to at least one geometric parameter of at least one optical interface of said target objective; and
providing, based on said at least one measured optical set, a data set, called estimated performance set, comprising estimated data relating to the performance of said target objective, by a characterization model previously trained with a database, called training database, of training sets constituted based on optical objectives with an architecture identical to that of said target objective.

2. The method according to claim 1, characterized in that the measuring step performs several optical interferometry measurements, providing one or more measured optical sets.

3. The method according to claim 1, characterized in that at least one measured optical set comprises, partially or wholly, raw measurement values provided by at least one optical interferometry measurement.

4. The method according to claim 1, characterized in that at least one measured optical set comprises at least one geometric value relating to at least one optical interface of the target objective, the measurement step comprising the following steps:
at least one optical interferometry measurement each providing raw data; and
calculating said at least one geometric value by processing of said raw data.

5. The method according to claim 1, characterized in that the characterization model comprises:
a neural network, in particular a regression neural network, and even more particularly a deep learning convolutional neural network, CNN,
a polynomial linear regression model,
a Gaussian equation, obtained by a least squares method; and
a statistical analysis method.

6. The method according to claim 1, characterized in that the training database comprises at least one training set obtained based on an objective forming part of a same batch of objectives as the target objective, during the manufacture of said batch of objectives.

7. The method according to claim 1, characterized in that at least one training set comprises:
at least one optical set, called training optical set, relating to an optical objective with an architecture identical to the architecture of the target objective; and
at least one performance set, called training performance set, comprising data relating to the performance of said optical objective.

8. The method according to claim 7, characterized in that, for at least one training set:
the training optical set is obtained by simulation; and/or
the training performance set is obtained by simulation.

9. The method according to claim 7, characterized in that at least one estimated performance set, respectively at least one training performance set, comprises:
at least one wavefront characterization measurement value, or
at least one modulation transfer function, MTF, value;
for at least one position on the optical objective.

10. The method according to claim 1, characterized in that it comprises, prior to the first iteration of the characterization phase, a phase of obtaining the characterization model with the training database.

11. A device for functional characterization, during manufacture or after manufacture, of a target optical objective comprising a stack of several optical elements, said device comprising:
an optical interferometry appliance for measuring, on said stack of optical elements, at least one data set, called measured optical set, comprising data relating to at least one geometric parameter of at least one optical interface of said target objective; and
a characterization model previously trained with a training database constituted on the basis of optical objectives with an architecture identical to that of said target objective in order to provide, based on said at least one measured optical set, a data set, called estimated performance set, comprising data relating to the performance of said target objective.

12. A method for manufacturing a batch of optical objectives including a second manufacture phase comprising at least one iteration of a step of manufacture of an optical objective of said batch comprising the following operations:
stacking the optical elements forming said optical objective; and
characterizing said objective by the characterization method according to claim 1.

13. The method according to claim 12, characterized in that it also comprises a first manufacture phase, prior to the second manufacture phase, comprising several iterations of a step of manufacture of an optical objective of the batch of objectives comprising the following operations:
stacking the optical elements forming said optical objective;
measuring, by optical interferometry, at least one training optical set on said optical objective;
measuring at least one training performance set; and
storing, in a training database, a training set formed by:
said at least one training optical set; and
said at least one training performance set.

14. A system for manufacturing optical objectives comprising:
at least one means of stacking the optical elements forming an optical objective; and
a device for characterizing said optical objective according to claim 11;
configured to implement a method for manufacturing a batch of optical objectives including a second manufacture phase comprising at least one iteration of a step of manufacture of an optical objective of said batch comprising the following operations:
stacking the optical elements forming said optical objective; and
characterizing said objective by a characterization method comprising a phase of characterization of a target optical objective comprising the following steps and performed after stacking said optical elements:
measuring, by optical interferometry on said stack of optical elements, at least one data set, called measured optical set, comprising data relating to at least one geometric parameter of at least one optical interface of said target objective; and
providing, based on said at least one measured optical set, a data set, called estimated performance set, comprising estimated data relating to the performance of said target objective, by a characterization model previously trained with a database, called training database, of training sets constituted based on optical objectives with an architecture identical to that of said target objective.
